(19) United States
(12) Patent Application Publication
(10) Pub. No.: US 2010/0282722 A1
(43) Pub. Date: Nov. 11, 2010

(54) LASER BEAM WELDING DEVICE AND METHOD

(75) Inventors: Reiner Ramsayer, Schwieberdingen (DE); Sonja Kittel, Stuttgart (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/599,210

(22) PCT Filed: Jul. 2, 2008
(86) PCT No.: PCT/EP2008/058526

§ 371 Date: Nov. 6, 2009

(30) Foreign Application Priority Data
Jul. 13, 2007 (DE) 102007032744.9

(51) Int. Cl. B23K 26/00

(52) U.S. Cl. 219/121.64; 219/121.63

(57) ABSTRACT

A laser beam welding device having a laser scanner to displace a laser beam along a specified path in a first direction of motion on at least one workpiece. A driving arrangement is provided for driving the workpieces in a second direction of motion so as to increase the relative speed between the laser beam and the workpiece. A laser beam welding method is also provided.

### FIELD OF THE INVENTION

The present invention relates to a laser beam welding device and a laser beam welding method.

### BACKGROUND INFORMATION

In laser beam welding, the laser beam is focused in the joining zone (weld zone) of two or more workpieces that are to be welded. The absorption of the laser beam leads to the heating and melting and often to the partial vaporization of the material. The welding connection is created by the intermixture taking place during the joining of several workpieces of the melt and the subsequent re-solidification of the material. Because of the local thermal expansion, perhaps a microstructural transformation and the solidification of the material, an undesired delay occurs, which may lead to shape changes and dimensional changes in the component made up of the workpieces, and consequently to functional impairments, and, in the least favorable case, to failure of the component. Cracks may form during welding, especially during the welding of dissimilar materials, i.e., different materials, based on different thermal coefficients of expansion.

In the usual welding of peripheral seams, a nonuniform and asymmetrical heating of the joining zone takes place, based on an unavoidable overlapping zone which is traveled over twice by the laser beam. This asymmetry leads to a axial runout and a deviation in dynamic balance of the component, which may be especially critical during laser welding of valve seats and may impair the sealing function of the valve.

There exist various method strategies for avoiding these disadvantages. One attempt at reducing the component delay is the homogeneous application of energy, that is, a uniformly symmetrical heating of the joining zone, as is described in German Patent Application No. DE 100 20 327 A1.

In quasi-continuous plastic welding, one may deflect the laser beam using a scanner, and move it along a specified path in a first direction of motion on a workpiece or a joining zone between two workpieces. At a sufficiently high speed of motion of the laser beam, the material is melted in the joining range, and during the molten state, the beam is made to travel across it before solidification sets in. The result is that, during a certain time period, a uniformly molten joining range is created which solidifies uniformly when joining takes place.

The procedure described is not practicable for welding metallic workpieces. A uniformly molten joining zone is not able to be implemented using a laser scanner especially if two workpieces having a large diameter are to be welded together, that is, if the path to be traveled by the laser beam is comparatively long.

### SUMMARY

An object of the present invention is to provide a laser beam welding device that is suitable for welding together two metallic workpieces. A further object is to provide a correspondingly improved laser beam welding method.

To avoid repetition, features described herein in terms of the device also apply to the method. Likewise, features described herein in terms of the method shall also apply to the device.

In accordance with the present invention, it is recognized that the threshold speed, as of which a uniformly molten joining zone is created, is a function of the component geometry, the melting temperature and the thermal conductivity of the material to be joined, or rather, the materials to be joined. Furthermore, depending on the material, a more or less great draining away of the energy or heat into the material results, and cooling and solidification set in the joining zone. In order to produce and maintain the molten state, the energy flow applied should be at least as great as the draining energy flow. Up to the present, the method of using a laser scanner for metallic materials was not practicable, since, because of the higher coefficient of thermal conductivity of metal, and the higher energy loss because of the draining of heat into the component connected with it, considerably higher speeds of the laser beam, or rather the focus point, are required than is achievable using a usual laser scanner. According to the present invention, not only is the focus of the laser beam moved along a specified path in a first direction of motion on a workpiece, or in the joining zone of at least two workpieces, but also the workpiece or the workpieces are impelled in a second direction of motion, in such a way that an increased relative speed comes about between the focus of the laser beam and the workpiece(s) that are to be joined. The laser beam welding method according to the present invention provides for driving the workpiece(s) in the second direction of motion. The driving arrangement is preferably developed and situated in such a way that it drives the at least one workpiece, together with a corresponding fixing device for holding it, i.e., fixing the at least one workpiece. Because of the increased relative speed between the focus of the laser beam and the workpiece or the joining range, uniform heating may be implemented along the entire joining range, and consequently uniform melting of the at least one workpiece. The laser beam welding device and the laser beam welding method according to the present invention are particularly suitable for welding metallic workpieces, especially if they are made of different metals or metal alloys.

Since the welding seam is generated by passing over it several times, and the application of the energy is improved in response to heated or molten material, in order to achieve a certain welding depth, laser beam sources may also be used that have a lower power delivery than are used for welding workpieces using only one pass. For instance, the use of CW lasers having average peak powers is possible.

Especially good results may be achieved in the case of delay-critical workpieces having a diameter of less than 12 mm, whereas by increasing the relative speed, particularly by increasing the displacing speed of the laser beam focus, workpieces having a larger diameter are also able to be welded to each other.

Particularly high relative speeds between the focus of the laser beam and the at least one workpiece may be implemented in that the first direction of motion, in which the laser beam is moved along the specified path in the joining range, and the second direction of motion in which the workpiece or workpieces is/are driven run counter to each other, that is, the focus of the laser beam and the workpiece are moved in opposite directions.

The laser beam welding device and the laser beam welding method are particularly suitable for generating annular, i.e., circumferentially closed welding seams, the welding seams to be generated being able to be generated, for example, on a flat surface, such as the end face of a workpiece or even on the circumference of at least one workpiece. For this purpose, the at least one workpiece is preferably driven rotating about a rotational axis by the driving arrangement. It is also possible to control the axis of rotation about which the workpiece is rotating along an encircling path, in particular, in order to be able to organize uniformly the energy application even in the case of complex workpiece geometries. It is also possible that the path passed over by the laser beam is not closed when the workpiece is driven in rotating fashion. This may be implemented, for example, if the laser is shut off or deflected in a certain circumferential section. However, one specific embodiment is particularly preferred in which the laser beam welding device is developed in such a way that a circumferentially closed, i.e., annular welding seam is produced.

In the simplest case, the path on which the focus of the laser beam moves, is annular. An annular path is particularly suitable for welding rotationally symmetrical workpieces. In this case, the workpieces to be welded are moved in a rotational manner about the axis of rotation.

Especially in the case of the rotational driving of the at least one workpiece, care should be taken that undesired effects, such as humping or the expulsion of the melt, because of the centrifugal force, is avoided. Experiments have shown that the limit of the rotational speed with respect to the expelling of the melt during the welding of round steels having a diameter of 6 mm may be approximately 1200 rev/min, which is equivalent to a path speed of approximately 30 m/min. If a displacement speed of the laser beam focus, in the opposite direction, is taken into account, having a speed of about 60 m/min, a welding speed (relative speed) of about 90 m/min may be implemented.

Particularly preferred is one specific embodiment in which the path, along which the laser beam, or rather, the laser beam focus is able to be displaced in the joining range, is programmable. The path is preferably programmed in such a way that the path corresponds at least approximately to the contour of the workpiece, especially taking into consideration the rotational motion of the workpieces.

In practice, producing a welding seam located at the circumference of at least one workpiece creates great difficulties. In order to produce a welding seam that extends over the circumference of at least one, preferably two closely adjoining workpieces, an arrangement for imaging the path at the circumference is provided in a refinement of the present invention. This arrangement is developed in such a way that it deflects an approximately axial laser beam outwards or inwards in the radial direction, depending on whether the welding seam is to be produced at the inner or the outer circumference of the workpiece.

Particularly good results may be achieved when the arrangement, for imaging the path of the laser focus at the circumference of the at least one workpiece, is developed as a conical mirror or a parabolic mirror, or included a conical mirror or a parabolic mirror, the conical mirror or the parabolic mirror, preferably being developed as an internal or an external mirror, depending on whether the welding seam was to be produced at the outer or the inner circumference of the workpiece. Providing a conical or parabolic-shaped mirror is advantageous; however, other geometric mirror shapes may be provided for deflecting the laser beam to the circumference of the at least one workpiece. In addition or alternatively to programming the path of the laser beam focus by a suitable development of the laser scanner, it is possible to adapt the shape of the arrangement for imaging the path at the circumference, particularly the shape of the conical mirror, to the contour of the workpiece or the workpieces or the welding seam that is to be produced.

### BRIEF DESCRIPTION OF THE DRAWINGS

Additional features, advantages and details of the present invention are described below in the context of preferred exemplary embodiments.

FIG. 1 shows a laser beam welding device for producing a welding seam at an end face.

FIG. 2 shows a laser beam welding device for producing a welding seam situated at the outer circumference of a workpiece.

FIG. 3 shows a laser beam welding device for producing a welding seam situated at the inner circumference of a workpiece.

### DETAILED DESCRIPTION OF EXAMPLE EMBODIMENTS

Identical components and components having the same function are labeled by the same reference symbols as in the figures.

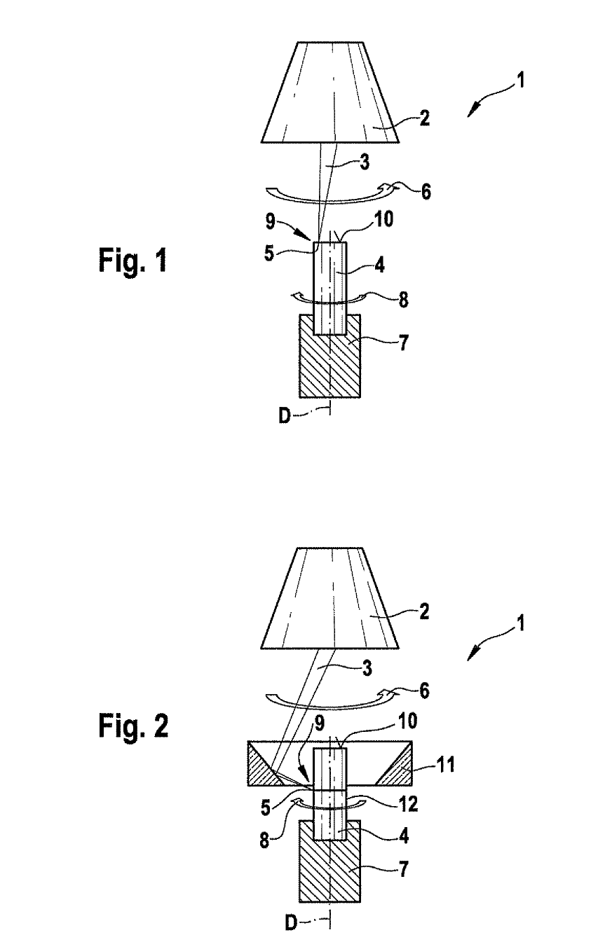

FIG. 1 shows a laser beam welding device 1. Laser beam welding device 1 includes a laser scanner 2 having a laser beam source for generating a laser beam 3 and for displacing, that is, moving laser beam 3 along a specified annular path that runs along an end face, in this exemplary embodiment, between a first workpiece 4 and a second workpiece 10 at the end face, that is developed as a cover. Using laser beam welding device 1 that is shown, an annular welding seam, lying in an end face plane, is able to be produced between workpieces 4, 10. Laser beam 3, or rather, focus 5 of laser beam 3, in this exemplary embodiment, is moved at a speed of about 60 m/min in a first direction of motion 6, in a counterclockwise direction. First workpiece 4, in common with second workpiece 10, is driven, rotationally clockwise, with the aid of driving means 7 about an axis of rotation D in a second direction of motion 8, which is directed counter to first direction of motion 6. This yields a speed of workpieces 4, 10 of about 30 m/min in joining range 9. Overall, there results from this a relative speed between workpieces 4, 10 and focus 5 of laser beam 3, that is, a welding speed of about 90 m/min. Because of this, workpieces 4, 10 are homogeneously melted in annular joining range 9. In the exemplary embodiment shown, both workpiece 4 and second workpiece 10, that is developed as a cover, are made of steel.

FIG. 2 shows an alternative laser beam welding device 1. It includes a laser scanner 2 for producing and displacing a laser beam 3. Laser beam 3 is driven counterclockwise, rotationally in a first direction of motion 6. Laser beam 3, which is radiated approximately in the axial direction, impinges upon a conical mirror 11, having an inner cone, and is deflected inwards by this in the radial direction to outer circumference 12 of first 4 and second workpiece 10, so that focus 5 moves in first direction of motion 6 in the circumferential direction at outer circumference 12 of adjacent workpieces 4, 10. In order to increase the welding speed and thereby to implement a homogeneous melting in joining range 9, workpieces 4, 10 are rotated with the aid of driving means 7 rotationally clockwise about rotational axis D in a second direction of motion 8.

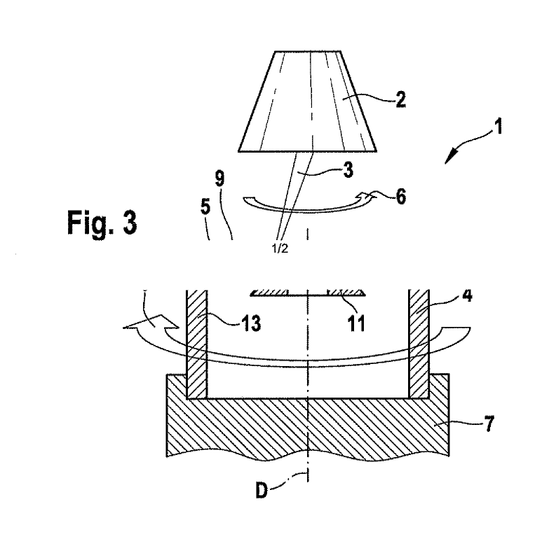

The exemplary embodiment shown in FIG. 3 corresponds generally to the exemplary embodiment according to FIG. 2, the difference being that laser beam 3, or rather, its focus 5, is moved at the inner circumference of workpieces 4, 10, along a first direction of motion 6, in the counterclockwise direction. In order to make this possible, a conical mirror 11 having an outer cone is situated inside hollow cylindrical workpieces 4, 10, so that laser beam 3, impinging from the axial direction on conical mirror 11, impinges outwards in the radial direction upon inner circumference 14 in joining range 9, in the contact region of workpieces 4, 10. Workpieces 4, 10 are driven with the aid of driving arrangement 7, rotationally in a second direction of motion 8, rotationally clockwise, counter to direction of motion 6.

1. (canceled)

14. A laser beam welding device, comprising:
a laser scanner to displace a laser beam along a specified path in a first direction of motion on at least one workpiece; and
a driving arrangement adapted to drive the workpiece in a second direction of motion so as to increase a relative speed between the laser beam and the workpiece.

15. The laser beam welding device as recited in claim 14, wherein the first and the second direction of motion are opposite to each other.

16. The laser beam welding device as recited in claim 14, wherein the driving arrangement is adapted to rotate the workpiece.

17. The laser beam welding device as recited in claim 14, wherein the path, along which the laser beam is displaced, is a closed path.

18. The laser beam welding device as recited in claim 14, wherein the path, along which the laser beam is displaced, is an annular path.

19. The laser beam welding device as recited in claim 14, wherein the path, along which the laser beam is displaced, is programmable in such a way that the path corresponds to a contour of the workpiece.

20. The laser beam welding device as recited in claim 14, further comprising:
an imaging device adapted to image the path at least one of an outer and inner circumference of the workpiece.

21. The laser beam welding device as recited in claim 20, wherein the imaging device is adapted to deflect an approximately axial laser beam inwards or outwards in a radial direction.

22. The laser beam welding device as recited in claim 21, wherein the imaging device includes at least one of a conical mirror and a parabolic mirror.

23. A laser beam welding method, comprising:
displacing a laser beam along a specified path in a first direction of motion on at least one workpiece; and
driving the workpiece in a second direction of motion so as to increase a relative speed between the laser beam and the workpiece.

24. The laser beam welding method as recited in claim 23, wherein the workpiece is driven in rotating fashion.

25. The laser beam welding method as recited in claim 23, wherein the first direction of motion and the second direction of motion are opposite to each other.

26. The laser beam welding method as recited in claim 23, wherein at least one of the workpiece is driven at a speed of less than 40 m/min, and the laser beam is driven along the path at a speed of more than 40 m/min.

27. The laser beam welding method as recited in claim 23, wherein at least one of the workpiece is driving at a speed of less than 35 m/min, and the laser beam is driven along the path at a speed of more than 50 m/min.

28. The laser beam welding method as recited in claim 23, wherein at least one of the workpiece is driving at a speed of less than 30 m/min, and the laser beam is driven along the path at a speed of more than 60 m/min.
